(19) United States
(12) Patent Application Publication
(10) Pub. No.: US 2010/0268856 A1
(43) Pub. Date: Oct. 21, 2010

(54) FORMATTING MEMORY IN A PERIPHERAL DEVICE

(76) Inventor: Eric R. Smith, Halifax (CA)

Correspondence Address: CARR & FERRELL LLP, 2200 GENG ROAD, PALO ALTO, CA, 94303, US

(21) Appl. No.: 12/426,410

(22) Filed: Apr. 20, 2009

(51) Int. Cl. G06F 13/12; G06F 12/00; G06F 12/14

(52) U.S. Cl. 710/74; 711/166; 711/163; 711/103; 711/E12.001; 711/E12.008; 711/E12.092

(57) ABSTRACT

A system for formatting memory in a peripheral device. The system includes a peripheral device comprising the memory communicatively coupled with a controller. A host is communicatively coupled with the peripheral device via a communication path. An interface is communicatively coupled with the controller and the host computer. The controller is configured to receive a first command from the host computer. The controller is further configured to format at least a portion of the memory based on the first command. The host computer sends a second command to the peripheral device via the communication path to complete the format.

### CROSS-REFERENCE TO RELATED APPLICATION

The present application is related to U.S. patent application Ser. No. 12/412,844, filed Mar. 27, 2009 and entitled “Establishing a Secure Channel Between a Server and a Portable Storage Device,” hereinafter Secure Channel, the disclosure of which is incorporated herein by reference.

### BACKGROUND OF THE INVENTION

1. Field of the Invention

The present invention relates generally to data storage devices. More specifically, the present invention relates to formatting memory that resides in a peripheral device.

2. Related Art

Presently, data may be stored on a peripheral data storage device such as an external hard drive or a Universal Serial Bus (USB) flash drive, for example. These peripheral data storage devices often need to be formatted at some point. Peripheral data storage devices are often communicatively coupled with a host computer, and then formatted.

### SUMMARY OF THE INVENTION

Embodiments of the present invention allow for formatting memory in a peripheral device.

In a first claimed embodiment, a method for formatting memory in a peripheral device is disclosed. The method includes communicatively coupling the peripheral device with a host computer, the peripheral device comprising the memory communicatively coupled with a controller. The method also includes forming a communication path between the controller and the host computer. Additionally, the method includes receiving at the controller a first command from the host computer. The controller is instructed to perform a format in response to the first command. At least a portion of the memory is formatted by the controller based on the first command.

In a second claimed embodiment, a system for formatting memory in a peripheral device is set forth. The system includes a peripheral device comprising the memory communicatively coupled with a controller. A host is communicatively coupled with the peripheral device via a communication path. An interface is communicatively coupled with the controller and the host computer. The controller is configured to receive a first command from the host computer. The controller is further configured to format at least a portion of the memory based on the first command.

A third claimed embodiment discloses a computer readable storage medium having a program embodied thereon. The program is executable by a processor to perform method for formatting memory in a peripheral device. The method includes communicatively coupling the peripheral device with a host computer, the peripheral device comprising the memory communicatively coupled with a controller; forming a communication path between the controller and the host computer; receiving at the controller a first command from the host computer; instructing the controller to perform a format in response to the first command; and formatting at least a portion of the memory by the controller based on the first command.

### BRIEF DESCRIPTION OF THE DRAWINGS

FIG. 1 is a block diagram of an exemplary environment for practicing embodiments of the present invention.

FIG. 2 is a block diagram of an exemplary peripheral device employed in the environment of FIG. 1.

FIG. 3 is a block diagram of an exemplary memory included in the peripheral device of FIG. 2.

FIG. 4 is a block diagram of an exemplary publicly accessible part included in the memory of FIG. 2.

FIG. 5 is a flowchart of an exemplary method for formatting the peripheral device of FIG. 1 in a non-administrative mode.

### DETAILED DESCRIPTION OF EXEMPLARY EMBODIMENTS

The present invention provides methods and systems for formatting memory in a peripheral data storage device. In one exemplary embodiment, the formatting is performed in a non-administrative mode.

As mentioned herein, peripheral data storage devices can be communicatively coupled with a host computer, and then formatted. Typically this is done when the Operating System (OS) on the host computer grants write access to the peripheral data storage device.

Users often want to be able to format their peripheral devices. In various embodiments, the peripheral device might be a removable or unpluggable device (e.g., an external USB flash drive etc.). Generally, most OSs such as Windows XP, for example, will only let a user format a drive if the user is logged in as an administrative user and thus possesses some special privileges.

It would be desirable to be able to format the peripheral device without requiring that the OS grant write access to the peripheral device. This is because there are many situations in which the OS cannot or will not grant this access to a user (e.g., the user is running Windows XP and does not possess administrative privileges).

One of the issues with a device that is being used by a non-administrative user is that the OS controls the access to the device, and typically a regular user (i.e., a non-administrative user) is very restricted in what they can send to the device. The OS might let the user read and write but typically only in particular areas of the disc. The OS checks the file owners and permissions and other things. Consequently, it is not always possible in general to send information to a peripheral device. It would be desirable to have some way of letting arbitrary users send arbitrary chunks of data to a peripheral device. One might want that data to be encrypted or otherwise secured so that people cannot eavesdrop on the data.

One issue is that many users, especially in large corporations and other organizations, do not have administrative privileges. Thus, those users cannot format their drives. Traditionally, the drives are shipped preformatted. That can pose a problem if the peripheral devices being shipped are encrypted and the company (e.g., the manufacturer) shipping the peripheral devices does not have the keys. In such cases, the company would not be able to format the devices. The keys might be generated at the user side. Therefore, the company cannot write anything onto the drives before the user receives them. If the company has the keys they could pre-format, but that is undesirable for security reasons. Additionally, granting arbitrary write access might pose security issues.

It is therefore desirable to allow users to format drives even without administrator privilege (i.e., in a non-administrative mode). There should be some system and method for communicating data safely, or securely, to a peripheral device in a non-administrative mode. In various embodiments, it is also contemplated to communicate data securely to a peripheral device in an administrative mode or in other various other modes that exist or that might exist in the future. It is also contemplated that devices other than peripheral devices can be used in accordance with various embodiments.

As such, embodiments according to the present invention address the need for formatting memory in a peripheral device over a communication path. In various embodiments, it is envisioned to do this in non-administrative mode over a secure communications channel, as well as in other modes and over secure or unsecure communications channels.

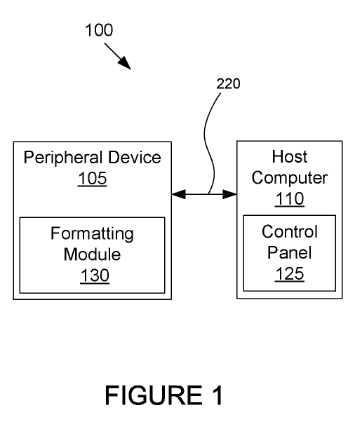

Referring now to FIG. 1, a block diagram of an exemplary environment 100 is presented. As depicted, the environment 100 includes a peripheral device 10 and a host computer 110. The peripheral device 105 is communicatively coupled with the host computer 110. It is noteworthy that these communicative couplings may be wireless or wired.

Additionally, as illustrated in FIG. 1 and explained in further detail herein, the peripheral device 105 includes a formatting module 130. The formatting module 130 can be stored as software, firmware, hardware, as a combination, or in various other ways. The formatting module 130 is configured to format at least a portion of memory on the peripheral device 105 when instructed by a controller or processor (not depicted).

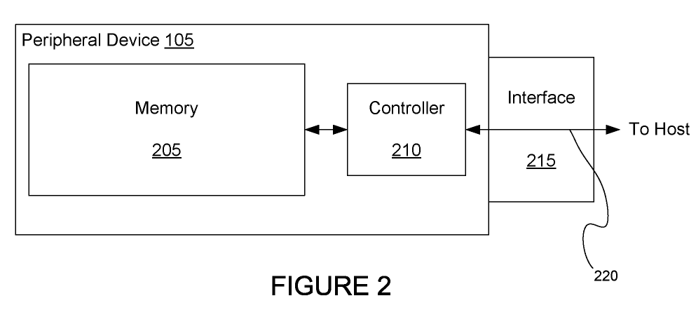

It is contemplated that the peripheral device 105 can include any device that is capable of storing digital information. In one embodiment according to aspects of the present invention, the peripheral device 105 can be a removable or unpluggable data storage device (e.g., a USB drive). The peripheral device 105 can be portable in one embodiment, but it is not limited to a portable device. For illustrative purposes, the peripheral device 105 is described herein in the context of a USB flash drive. The peripheral device 105 is discussed in further detail in connection with FIG. 2.

The host computer 110 includes any computing device that can interface with the peripheral device 105. Examples of the host computer 110 include a personal computer (PC), a personal digital assistant (PDA), a Smartphone, and other various devices. The host computer 110 includes one or more communications interfaces (not depicted) to facilitate communicative coupling with the peripheral device 105. Additionally, the host computer 110 can include a processor, memory such as random access memory (RAM), and storage such as read-only memory (ROM) (which are not depicted). Those skilled in the art will be familiar with the components and functionality of computing devices such as the host computer 110.

The host computer 110 is depicted as including the control panel 125. According to exemplary embodiments, the control panel 125 can be effectuated by instructions that are executed by the processor of the host computer 110. The control panel 125 can also allow a user to manage digital information stored within the peripheral device 105.

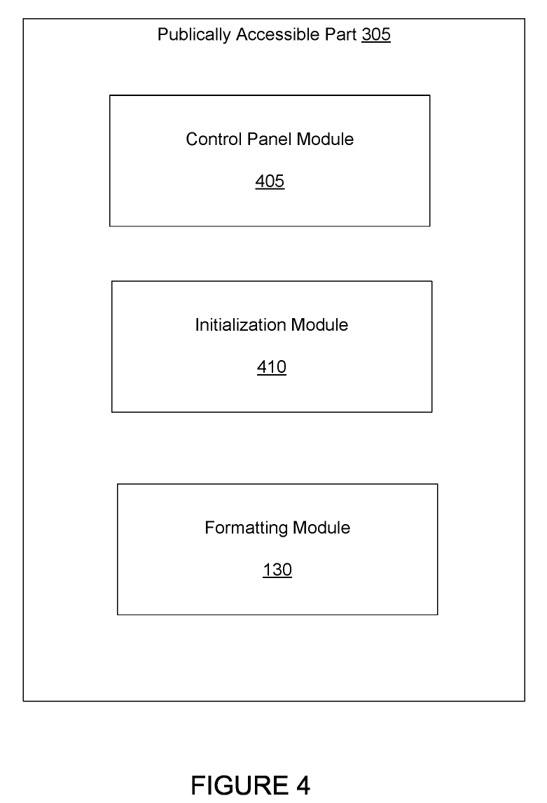

These instructions can be stored within the peripheral device 105 and retrieved by the host computer 110 for execution. In one embodiment, these instructions can be stored as software in control panel module 405 of FIG. 4. However, it is contemplated that the instructions can be stored as software, firmware, hardware, as a combination, or in various other ways. It is also envisioned that the instructions associated with the control panel 125 can be stored by the host computer 110, or stored remotely and accessed by the host computer 110 via a network.

FIG. 2 is a block diagram of the exemplary peripheral device 105 employed in the environment 100 of FIG. 1. The peripheral device 105 can be any device that is that is used to store digital information, and in one embodiment the peripheral device 105 is portable. In one embodiment, the peripheral device 105 depicted in FIG. 2 includes a memory 205, a controller 210, and an interface 215, which is a USB interface in one embodiment.

The memory 205 can include a computer-readable storage medium. While common forms of computer-readable storage media include, for example, a floppy disk, a flexible disk, a hard disk, magnetic tape, any other magnetic medium, a CD-ROM disc, digital video disc (DVD), and any other optical medium, the memory 205 is described in the context of non-volatile memory that can be electrically erased and rewritten. Examples of such non-volatile memory include NAND flash and NOR flash. Additionally, the memory 205 can comprise other existing memory technologies. The memory 205 can also comprise various other memory technologies as they become available in the future.

The controller 210 can be a processor or microcontroller with an amount of on-chip ROM and/or RAM. The controller 210 is communicatively coupled with the memory 205 and the interface 215. Additionally, the controller 210 can include software and/or firmware that can execute various modules, such as the formatting module 130 described herein. As such, the controller 210 functions as an intermediary between the host computer 110 and the memory 205. For example, the controller 210, or various modules executed thereby, can receive write commands from the host computer 110 and determine how data associated with those write commands is to be managed with respect to the memory 205.

As mentioned, the peripheral device 105 can be communicatively coupled with the host computer 110 in either a wireless or wired manner. The interface 215 facilitates this coupling by allowing information to be transferred between the peripheral device 105 and the host computer 110. In exemplary embodiments, the interface 215 includes a USB plug that is insertable into a mating USB port of the host computer 110. Alternatively, the interface 215 can include other standards for communicative coupling such as FireWire, Ethernet, Wireless USB, Bluetooth, or other standards. Furthermore, the interface 215 can comprise other interface technologies as they become available.

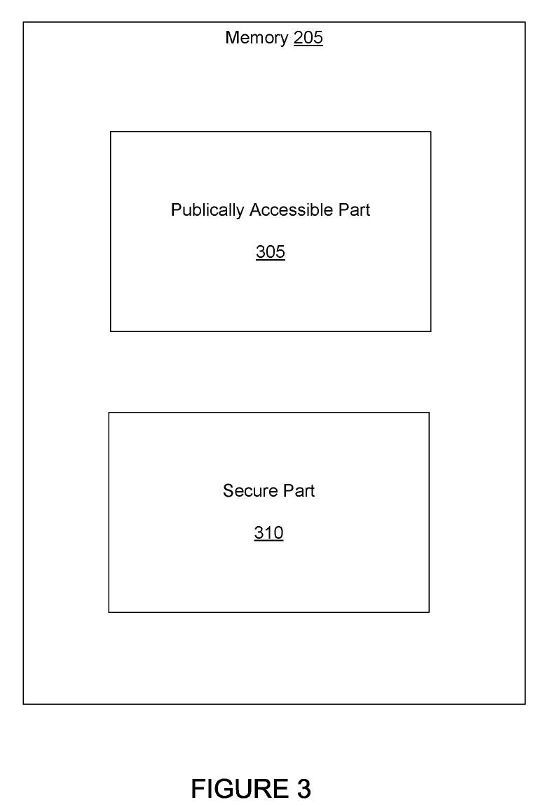

In keeping with embodiments according to aspects of the present invention, FIG. 3 is a block diagram of the exemplary memory 205 included in the peripheral device 105. The memory 205 includes a publicly accessible part 305 and a secure part 310. The publicly accessible part 305 is, in one embodiment, a CD-formatted partition. However, the publicly accessible part 305 could be formatted in another manner, such as like a hard drive for example. The publicly accessible part 305 is public; it may or may not be writable. It can have data on it already.

The secure part 310, in one embodiment, is secure and not public. The secure part 310 can be encrypted. According to various embodiments, the secure part 310, unlike the publicly accessible part 305, is not accessible until initialization time.

In accordance with various embodiments, the publicly accessible part 305, or certain modules thereof, can be included in the memory 205 and/or the controller 210. Similarly, the secure part 310, or certain modules thereof, can be included in the memory 205 and/or the controller 210.

In keeping with aspects of the invention, FIG. 4 is a block diagram of an exemplary publicly accessible part 305 included in the memory 205 of FIG. 2. In one embodiment, the publicly accessible part 305 includes a control panel module 405, an initialization module 410, and the formatting module 130. In alternate embodiments, one or more of the control panel module 405, the initialization module 410, and the formatting module 130 can be stored in a private area on the peripheral device 105 that is not accessible by the user.

The control panel module 405 can be software that includes instructions in the form of, for example, software for running control panel 125 of FIG. 1. As mentioned herein, control panel module 405 is not limited to being software. The initialization module 410 includes software that is used to initialize the peripheral device 105. It is contemplated that the formatting module 130 can be part of the control panel module 405 in exemplary embodiments.

It is noteworthy that, in various embodiments, a command is sent from the host computer 110 over the communication path 220 (e.g., an encrypted USB channel) to peripheral device 105 in order to have it format itself (at least in part) via the formatting module 130 and/or the control panel module 405, rather than having the peripheral device 105 formatted by the OS of the host computer 110. The solution provides a great deal of security. Since the format is performed on the peripheral device 105, viruses and similar malware will not affect it. In some embodiments, the formatting is performed partly on the peripheral device 105 and partly on the host computer 110.

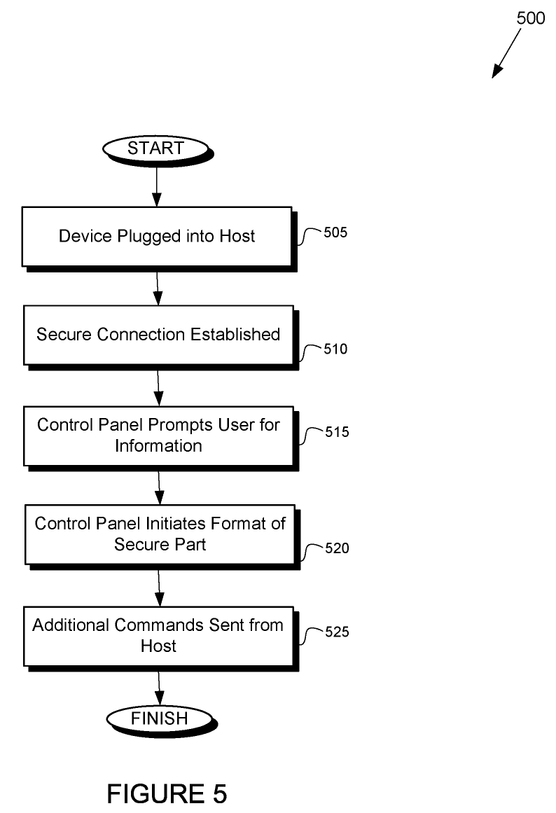

Turning to FIG. 5, a flowchart of an exemplary method 500 for formatting the peripheral device 105 of FIG. 1 is illustrated. As mentioned herein, this formatting is done in a non-administrative mode in one embodiment.

In step 505, the peripheral device 105 is communicatively coupled with the host computer 110. In exemplary embodiments, this coupling can be accomplished by plugging the peripheral device 105 into a USB port of the host computer 110, for example. The user runs set-up software, such as control panel module 405 from the publicly accessible part 305 (e.g., a public partition). As mentioned herein, the publicly accessible part 305 includes the control panel module 405, the initialization module 410, and the formatting module 130.

In step 510, the first thing, or one of the first things, that the control panel module 405 does when it runs is establish a secure connection to the peripheral device 105 device over a USB channel. In one embodiment, the communication path 220 is formed between the controller 210 and the host computer 110. The communication path 220 is an encrypted secure channel, in various embodiments, that allows the host computer 110 to talk to the peripheral device 105.

In step 515, the control panel 125 comes up on a screen of the host computer 110 and prompts a user to enter some information. For example, the user might be prompted to enter various information about the peripheral device 105. In exemplary embodiments, the control panel 125 prompts the user for a password that will be used to encrypt and decrypt data. The control panel 125 might also prompt the user for other things, such as the user's name and address in event the peripheral device 105 is lost.

In step 520, based on the information that the user has given the control panel 125, the control panel module 405 initiates a format of the secure part 310 of the peripheral device 105. It is noted that up until now the secure part 310 has not been formatted. The control panel module 405 causes the encryption key to be generated at initialization time using a random number generator on the peripheral device 105. In one embodiment the generated key is a symmetric key. However, it is envisioned that asymmetric keys could be used in alternative embodiments. The symmetric key is used for encrypting information that is written onto the secure part 310 of the memory 205 and decrypting it when that information leaves the secure part 310 of the memory 205.

The control panel 125 uses the communication path 220 to send over one or more first commands to format the peripheral device 105, based on the information the user has entered. Then the controller 210 takes those commands and, with the formatting module 130, executes them to format the secure part 310.

In one embodiment the first command simply instructs the controller 210 and/or the formatting module 130 to prepare a file system. For example, the controller 210 and/or the formatting module 130 can be instructed to zeroize some region of the secure part 310 of the memory 205. Those zeros are encrypted using the key that was established. But when they are read back they will be decrypted. So the peripheral device 105 is then set up into a sort of neutral status. The peripheral device 105 has right size but it is just filled with zeros.

In step 525, software running on the host computer 110, such as the control panel 125, completes the format by sending down one or more additional commands to the controller 210 so that specific blocks of data are written at the locations on the secure part 310 of the memory 205 where the OS of the host computer 110 designates. Various types of data can be sent, such as, for example, block size and cluster size. FAT data can be sent, such as FAT32 data for example, in a series of write commands that override the default (zero) format set up by the initial command. File System Information data can also be sent, as well as, for example, the first sector of the root directory.

Information that is written to the secure part 310 of the memory 205 is encrypted by the controller 210. In another embodiment, it is contemplated that the formatting module 130 performs all or some of the encryption. The secure part 310 is an encrypted file system, in one embodiment.

The control panel 125 will write, in one embodiment for the specific case of a Windows format, a BIOS parameter block (BPB) at sector offset zero of the peripheral device 105. And it writes file allocation table (FAT) information at the beginning of the peripheral device 105.

The idea is to provide enough basic information that Windows, or another OS, can recognize the secure part 310 of the peripheral device 105 (it can already recognize the publicly accessible part 305), and from that point on it is up to the OS to write the files etc.

One noteworthy feature is that because the communication path 220 is being employed, which has already been set-up and which works in non-administrative mode, OS privileges are not required that would normally be there to do various things. For example, normally Windows will only let a user format a drive if the user is an administrator. However, since the communication path 220 is being implemented it can be used as something akin to a back door. The communication path 220 can be used to allow the host computer 110 to talk to the peripheral device 105, get it to zeroize, and get it to write small amounts of data that are non-zero without OS intervention. It does not matter what the permissions are. Verification is performed on the device side. The system ensures that it is a sensible format or at least that it is not exceeding the bounds of the peripheral device 105.

It is envisioned that a fast format approach is taken in accordance with exemplary embodiments. However, it should be noted that a full format other approaches can be taken in alternative embodiments.

One notable feature is the flexibility this system and methodology offers due in part at least to the fact that in one embodiment the final format is performed by the host software, e.g. the control panel 125. In the case of some other devices (e.g., digital cameras), the formatting is accomplished by sending a command across a USB bus to the device. But in the case of a digital camera, the digital camera typically performs the whole format, and so it is locked into one particular type of format. For example, the digital camera might be locked into a FAT32 file system of a certain size, etc.

In contrast, exemplary embodiments according to the present invention provide a greater deal of flexibility and allow various things to be changed. For example, a label that the user gives can be changed, the size of the format can be changed, etc. Two or more secure partitions can be accommodated, in exemplary embodiments. A FAT file system need not be implemented at all. One could use a Macintosh file system, or other various file systems now in existence or that might be created in the future. These choices can be made by a user via the control panel 125, in one embodiment.

On the device side, i.e. from the peripheral device 110, the system zeroizes. In an alternate embodiment, from the device side the system can write such that the secure part 310 is fully formatted, and then modify the format. For example, the peripheral device 105 can write a full FAT32 format, and then have the host computer 110 override certain elements of it.

Another noteworthy feature of exemplary embodiments is that the host computer 110 and the peripheral device 105 cooperate on the format. In one embodiment, the bulk of the formatting is done on the peripheral device 105. The benefit of that is that not a lot of data has to be sent over the communication path 220. This can be an advantage because it is possible that the communication path 220 might be relatively slow in some embodiments.

Due at least in part to limitations of the communication path 220, it might not be desirable to write down a whole drive's worth of data from the host computer 110 to the peripheral device 105. It is desirable to have a lot of the work done on the peripheral device 105 side. However, at the same time it is desirable to be able to write some data down so that the user can modify format parameters. Due to this cooperation between the host computer 110 and the peripheral device 105, a user is not locked into a specific format being preset on the peripheral device 105 side. A user can update the control panel 125 to change the kinds of format etc., so the system is flexible. And at the same time the system does not have to write large amounts of data over what might be a slow connection. This methodology provides for a fast format that is flexible.

If the format were being driven by the host computer 110 alone, a large amount of data would traverse a USB bus, and presumably go over the communication path 220, in the case of a non-administrative format.

However, it is preferable to have as much of the data as possible generated on the peripheral device 105 itself, so that it does not have to be sent over the communication path 220. However, as mentioned herein, we want to be able to modify some elements of the format to customize it.

In summary, the ability to do this formatting as a non-administrative user is valuable. There is minimum data transfer to the host computer 105 and a minimum amount that the host has to send to the peripheral device 105, because the peripheral device 105 can do the majority of the work, i.e. writing large amounts of data.

Having a flexible format, while still being able to perform a fast format, is also a benefit. Having a “flexible format,” as the term is used herein, means the host computer 110 can control elements of the format, and cooperates with the peripheral device 105. Virtually any element of the format can be overridden in one embodiment.

More complicated formats, or new innovations in formatting, can be accommodated without needing to upgrade the device firmware, and the format code itself is free of the constraints which may be imposed by the limiting computing resources of typical removable storage devices. However, initial preparation (such as erasing the file system area) is performed on the peripheral device 105 itself, to provide faster operation. This is particularly useful if the communication path 220 offers only limited bandwidth.

Another noteworthy feature of exemplary embodiments is that the user can own and maintain control of the key(s) for formatting. The manufacturer and/or shipper of the peripheral device 105 does not have the key, in one embodiment. This scenario provides for increased security.

As mentioned herein, performing these methods over a secure channel is not necessary in some embodiments. Any kind of connection, or communicative coupling, of the peripheral device 105 with the host computer 110 is contemplated. Of course, for the purposes of performing the format in a non-administrative mode, it is desirable to have some kind of connection or communicative coupling that a regular user without administrative privileges can access.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for formatting memory in a peripheral device, the method comprising:
communicatively coupling the peripheral device with a host computer, the peripheral device comprising the memory communicatively coupled with a controller;
forming a communication path between the controller and the host computer;
receiving at the controller a first command from the host computer;
instructing the controller to perform a format in response to the first command; and
formatting at least a portion of the memory by the controller based on the first command.

2. The method of claim 1, wherein the host computer is running in a non-administrative mode during the formatting.

3. The method of claim 1, wherein the first command from the host computer instructs the controller to prepare a file system.

4. The method of claim 1, further comprising the host computer sending a second command to the peripheral device via the communication path to complete the format.

5. The method of claim 4, wherein completing the format includes sending data related to a specific type of file system used.

6. The method of claim 4, wherein completing the format includes sending data related to a FAT family of file systems.

7. The method of claim 4, wherein completing the format includes sending data related to a volume label.

8. The method of claim 1, wherein the file system is encrypted.

9. The method of claim 8, wherein the file system is encrypted with an encryption key generated by the peripheral device.

10. The method of claim 1, further comprising securing the communication path such that the communication path is an encrypted channel.

11. The method of claim 1, wherein formatting at least a portion of the memory comprises formatting an encrypted memory.

12. The method of claim 1, wherein forming the communication path comprises establishing the communication path through a control panel.

13. The method of claim 1, wherein the communication path is a secure channel.

14. A system for formatting memory in a peripheral device, the system comprising:
a peripheral device comprising the memory communicatively coupled with a controller;
a host communicatively coupled with the peripheral device via a communication path; and
an interface communicatively coupled with the controller and the host computer;
the controller configured to receive a first command from the host computer;
the controller further configured to format at least a portion of the memory based on the first command.

15. The system of claim 14, wherein the host computer is running in a non-administrative mode during the formatting.

16. The system of claim 14, wherein the first command from the host computer instructs the controller to prepare a file system.

17. The system of claim 14, wherein the host computer is configured to send a second command to the peripheral device via the communication path to complete the format.

18. The system of claim 14, wherein the communication path is a secure channel.

19. The system of claim 14, wherein the memory comprises a public portion.

20. The system of claim 14, wherein the memory comprises a secure portion.

21. The system of claim 14, wherein the peripheral memory comprises a public portion and a secure portion.

22. The system of claim 21, wherein the secure portion is an encrypted secure portion.

23. The system of claim 21, wherein the public portion comprises an initialization module stored in the memory of the peripheral device and executable by the controller to initialize formatting.

24. The system of claim 21, wherein the public portion comprises a control panel module stored in the memory of the peripheral device and executable by the controller to form the communication path.

25. A computer readable storage medium having a program embodied thereon, the program executable by a processor to perform a method for formatting memory in a peripheral device, the method comprising:
communicatively coupling the peripheral device with a host computer, the peripheral device comprising the memory communicatively coupled with a controller;
forming a communication path between the controller and the host computer;
receiving at the controller a first command from the host computer;
instructing the controller to perform a format in response to the first command; and
formatting at least a portion of the memory by the controller based on the first command.
